(19) United States
(12) Patent Application Publication
(10) Pub. No.: US 2019/0085626 A1
(43) Pub. Date: Mar. 21, 2019

(54) ADJUSTABLE ROLLER SHADE BRACKET WITH POSITIONAL INDICATOR

(71) Applicant: ZMC Metal Coating Inc., Woodbridge (CA)

(72) Inventor: Philip Ng, Thornhill (CA)

(73) Assignee: ZMC Metal Coating Inc., Woodbridge (CA)

(21) Appl. No.: 16/059,315

(22) Filed: Aug. 9, 2018

Related U.S. Application Data
(60) Provisional application No. 62/560,227, filed on Sep. 19, 2017.

(51) Int. Cl. E06B 9/44

(52) U.S. Cl. CPC E06B 9/44

(57) ABSTRACT

An adjustable end bracket for a roller blind, the end bracket including a bracket base configured for mounting to a structure, a mounting plate configured to support an end of a roller tube of the roller blind, the mounting plate slidably received on the bracket base and an adjustment mechanism to slidably alter the position of the mounting plate relative to the bracket base. The bracket further includes a first visual indicator on the mounting plate and a second visual indicator on the bracket base, the first and second visual indicators each comprising one or more index markings on the respective bracket base and the mounting plate, wherein the alignment or misalignment of the index markings signifies the position of the mounting plate relative to the bracket base and the degree of alteration of the relative position upon activation of the adjustment mechanism.

### CROSS REFERENCE TO RELATED APPLICATIONS

This patent application claims the benefit of and priority on U.S. Provisional Patent Application No. 62/560,227 having a filing date of 19 Sep. 2017.

### BACKGROUND OF THE INVENTION

### Technical Field

This invention relates generally to rollers blinds or shades, and in particular, to an end bracket for a roller blind.

### Prior Art

Roller blinds are a popular method to limit the intrusion of light through a window or other opening. Roller blinds can also be useful when positioned about a window for thermal and sound insulating purposes.

Roller blinds are typically comprised of a fabric or similar material, which is wound about a roller tube. The roller tube is suspended between two end brackets which are mounted on or about a window frame. Commonly, one of the end brackets houses or has otherwise associated with it the blind's primary drive mechanism (which may include a return spring, clutch, etc.). The other or opposite end bracket is typically associated with an idle end which serves to support the opposite end of the roller tube.

In use, it is usually desirable for the roller tube to be mounted parallel with the top of the window frame and/or for the bottom edge of the blind fabric to be parallel to the bottom edge or ground surface to which the shade extends. This often requires very precise positioning of the end brackets. However, a number of factors may cause the roller tube and/or the bottom edge of the blind fabric to be at an angle relative to their corresponding top edge or bottom edge/ground surface.

One such factor could be that the edges or the sides of the window frame to which the roller blind is being secured do not meet at right angles. Another factor could be that the top edge of the frame is not parallel with the bottom edge or ground surface. A further factor could simply be that the end brackets were mounted unevenly. A combination of any such factors could also cause a misalignment of the roller blind and the window frame.

One potential solution is to remove the end brackets and remount them. However, such a process tends to be time and labour intensive.

### BRIEF SUMMARY OF THE INVENTION

The invention therefore provides an adjustable end bracket for a roller blind, the end bracket including a bracket base configured for mounting to a structure, a mounting plate configured to support an end of a roller tube of the roller blind, the mounting plate slidably received on the bracket base and an adjustment mechanism to slidably alter the position of the mounting plate relative to the bracket base. The bracket further includes a first visual indicator on the mounting plate and a second visual indicator on the bracket base, the first and second visual indicators each comprising one or more index markings on the respective bracket base and the mounting plate, wherein the alignment or misalignment of the index marking on the bracket base with the index markings on the mounting plate signifies the position of the mounting plate relative to the bracket base and the degree of alteration of the relative position upon activation of the adjustment mechanism.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper front perspective view of a typical roller blind employing an end bracket in accordance with an embodiment of the invention;

FIG. 2 is a front elevation view of the roller blind of FIG. 1;

FIG. 3 is an enlarged, isolated view of the end bracket shown in FIG. 1;

FIG. 4 is an exploded view of the end bracket of FIG. 3;

FIG. 5 is a front elevation view of the end bracket of FIG. 3 in a first configuration;

FIG. 6 is a view of the end bracket of FIG. 3 in a second configuration;

FIG. 7 is a view of the end bracket of FIG. 3 in a third configuration; and

FIG. 8 is a front elevation view of an end bracket in accordance with another embodiment of the invention.

### DETAILED DESCRIPTION OF PREFERRED EMBODIMENTS

The present invention may be embodied in a number of different forms. The specification and drawings that follow describe and disclose some of the specific forms of the invention.

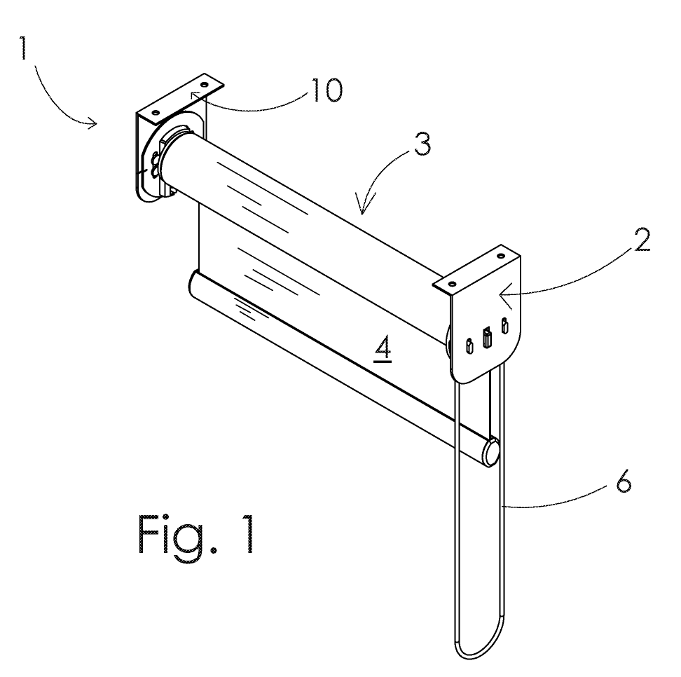

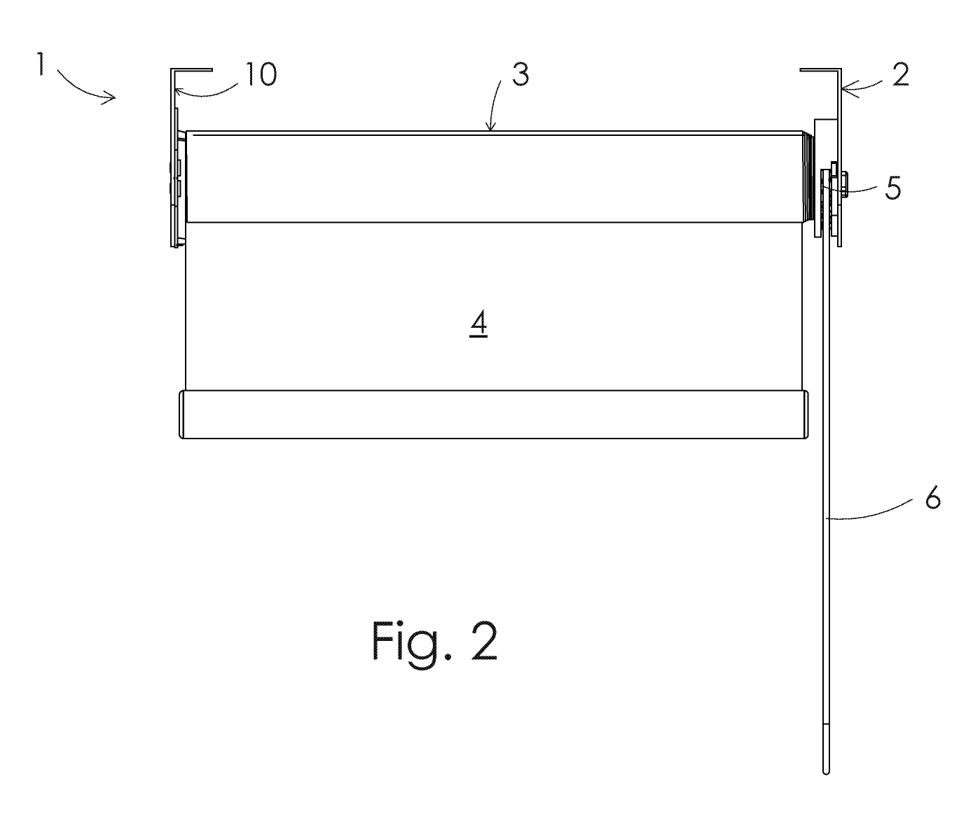

FIGS. 1 and 2 show a relatively standard roller blind 1 that is mounted to a surface through the use of a clutch end bracket 2 and an idle end bracket 10. Each end bracket is coupled to an end of a roller tube 3. Blind fabric 4 is received about roller tube 3 and is wound or unwound from the roller tube through the operation of a clutch 5 which is activated by a chain or cord 6.

In the embodiment shown, one end of roller tube 3 is associated with clutch 5, typically referred to as a clutch end 6. The opposite end of roller tube 3 is often referred to as an idle end. The idle end is typically secured to the roller tube, and generally serves to hang the end of roller tube 3, opposite the clutch, to its corresponding idle end bracket 10.

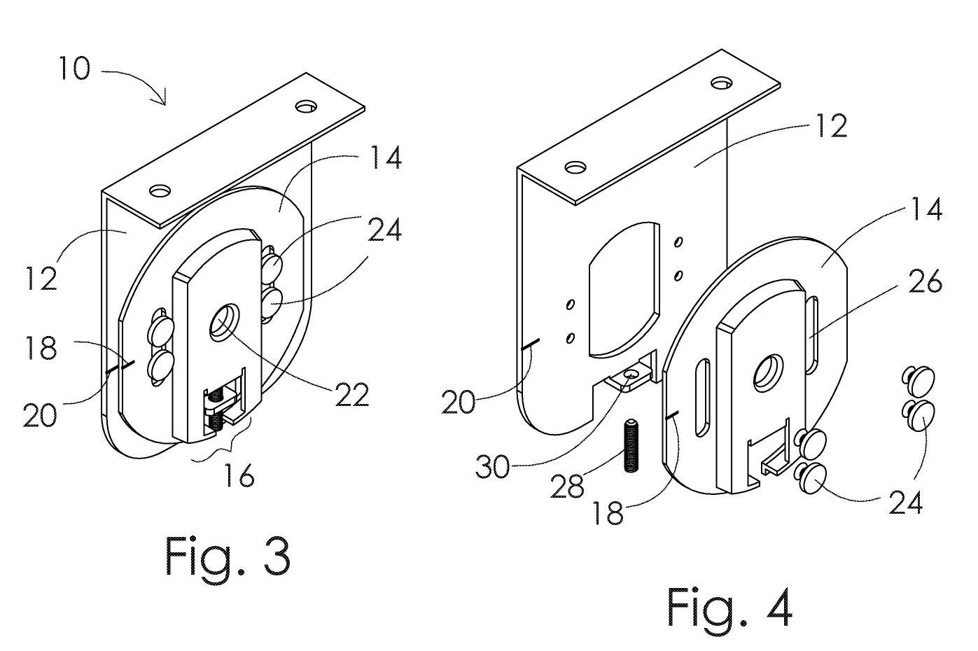

With reference to FIGS. 3 and 4, idle end bracket 10 includes a bracket base 12, a mounting plate 14, an adjustment mechanism 16, and visual indicators on bracket base 12 and mounting plate 14.

Bracket base 12 has apertures for receiving fasteners therethrough, thus allowing idle end bracket 10 to be mounted to a structure or window frame (not shown).

Mounting plate 14 includes an opening 22 for receiving and supporting the pin of the idle end of roller tube 3. In the particular embodiment depicted, mounting plate 14 is slidably secured to bracket base 12 via vertically aligned rivets 24 which are received through elongate apertures 26 in mounting plate 14. When assembled, the heads of rivets 24 sit adjacent the exterior face of mounting plate 14, allowing elongate apertures 26 (and hence mounting plate 14) to slide relative to the shafts of rivets 24. As will be readily understood by one skilled in the art, other structures and assemblies may be used to slidably secure mounting plate 14 to bracket base 12.

Idle end bracket 10 further includes adjustment mechanism 16 for slidably altering the position of mounting plate 14 relative to bracket base 12. As shown, adjustment mechanism 16 may include a threaded bolt 28 threaded into a bore 30 in bracket base 12. In this manner, rotating bolt 28 causes a change in the position of mounting plate 14 relative to bracket base 12 (i.e. shifts mounting plate 14 vertically up or down relative to bracket base 12).

Idle end bracket 10 further includes first and second visual indicators. As show, the first visual indicator is situated on mounting plate 14 and the second visual indicator is situated on bracket base 12. The first and second visual indicators may each include one or more index markings, respectively, 18 and 20 on their respective bracket base and mounting plate. In this manner, the alignment or misalignment of index marking 20 on bracket base 12 with index markings 18 on mounting plate 14 signifies the position of mounting plate 14 relative to bracket base 12.

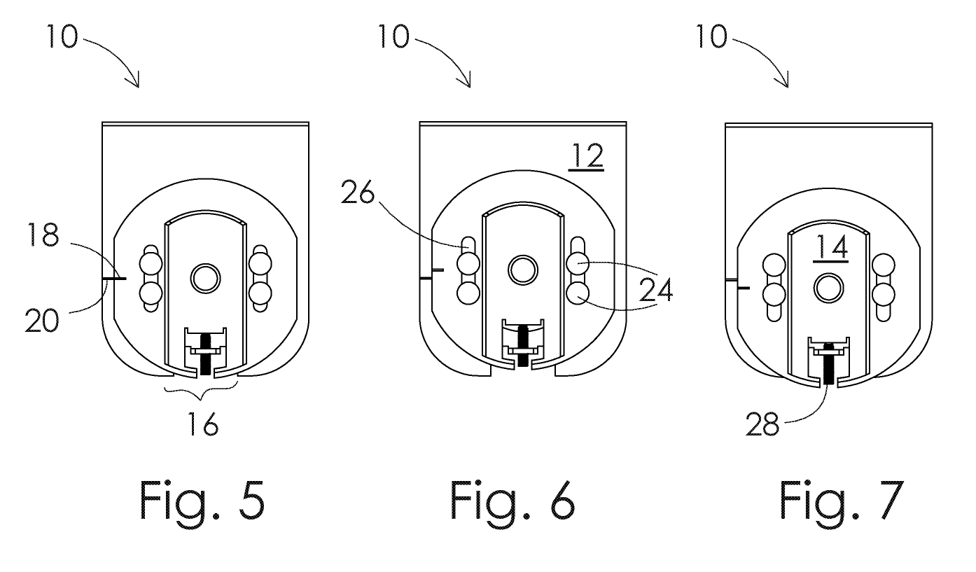

Turning now to FIGS. 5, 6, and 7, there is shown idle end bracket 10 in three different configurations. FIG. 5 depicts idle end bracket 10 when index markings 18 and 20 are aligned. FIGS. 6 and 7 depict idle end bracket 10 when index markings 18 and 20 are misaligned and mounting bracket 14 is either shifted higher or lower relative to bracket base 12.

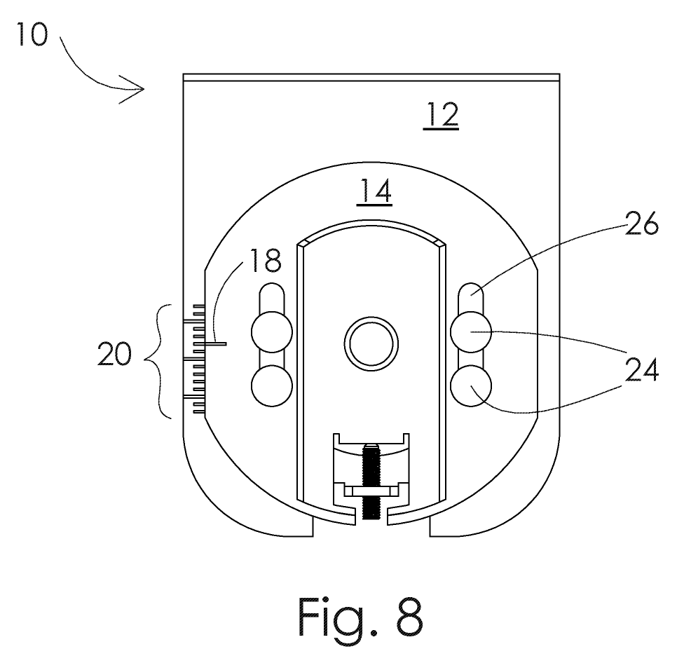

In an alternative embodiment, the index markings may include a set of generally parallel markings on bracket base 12 or a set of generally parallel markings on mounting plate 14. Each of the markings may be equally spaced apart by a pre-determined distance (for example 1 mm), to permit a more precise and measured visual assessment of the position of bracket base 12 relative to its associated mounting plate 14. For example, in the embodiment shown in FIG. 8, base bracket 12 has multiple index markings 20 representing a scale, while mounting plate 14 has a single marking or pointer as its index marking 18.

The index markings may be lines painted or scored on bracket base 12 and/or on mounting plate 14. The index marking may also be coloured so as to contrast with the colour of bracket base 12 and mounting plate 14. The colour of the markings on bracket base 12 may be difference from hose on mounting plate 14.

Idle end bracket 10, as described above, thus aids in allowing an installer to visualize the position of mounting plate 14 relative to bracket base 12 and to visualize the degree of shifting of the mounting plate upon operation of bolt 28 such that roller tube 3 may be more readily horizontally shifted relative to the window frame. For example, if one end of the bottom edge of the blind fabric is found to be four millimeters higher than the other end of the bottom edge of the blind fabric, bolt 28 can be rotated to slide mounting plate 14 four millimeters up or down (as required) relative to bracket base 12, thereby shifting roller tube 3 to horizontally level out the bottom edge of the blind fabric. Neither of the end brackets needs to be removed in order for such adjustments to be made.

Further, the utilization of multiple markings set an equal distance apart will permit an installer to more easily and more quickly adjust the end of the roller tube to horizontally level the blind fabric. For example, if adjacent markings are 1 mm apart, an installer can simply measure the gap between the bottom of the blind fabric and the bottom of the window sill and then apply that measurement when rotating bolt 28 by visually noting the relative measurement of index markings 18 and 20. Through noting the degree of movement between markings 18 and 20 as bolt 28 is rotated, the installer will be able to approximate the distance that the blind fabric at one end of the blind has been raised or lowered without needing to continually climb up and down a ladder to take measurements at the bottom of the window.

While the adjustable mounting plate as described is shown to be suspended from an idle end bracket, a skilled person would readily understand that clutch end brackets may also, or alternatively, be configured to include adjustable mounting plates so that the clutch end may be vertically shifted relative to the window frame when the clutch end bracket is mounted thereto.

The scope of the claims should not be limited by the preferred embodiments set forth in the examples, but should be given the broadest interpretation consistent with the description as a whole.

What is claimed is:

1. An adjustable end bracket for a roller blind, the end bracket comprising:
a bracket base configured for mounting to a structure;
a mounting plate configured to support an end of a roller tube of the roller blind, the mounting plate slidably received on the bracket base;
an adjustment mechanism to slidably alter the position of the mounting plate relative to the bracket base;
a first visual indicator on said mounting plate and a second visual indicator on said bracket base, said first and second visual indicators each comprising one or more index markings on said respective bracket base and said mounting plate, wherein the alignment or misalignment of said index marking on said bracket base with the index markings on said mounting plate signifies the position of the mounting plate relative to the bracket base and the degree of alteration of said relative position upon activation of the adjustment mechanism.

2. The end bracket as claimed in claim 1, wherein said index markings comprise a set of generally parallel markings on one of said bracket base and said mounting plate and a single marking or pointer on the other of said bracket base and said mounting plate, each of said markings of said set equally spaced apart by a pre-determined distance to permit a visual assessment of the distance of the sliding movement of said mounting plate relative to said bracket base upon operation of said adjustment mechanism.

3. The end bracket as claimed in claim 2, wherein said index markings comprise painted lines on said bracket base and on said mounting plate.

4. The end bracket as claimed in claim 2, wherein said index markings comprise scored lines on said bracket base and on said mounting plate.

5. The bracket as claimed in claim 3 or claim 4, wherein said index markings are coloured to be in contrast with the colour of said bracket base and said mounting plate.

6. The end bracket as claimed in claim 2, wherein said adjustment mechanism comprises a threaded bolt threaded into a bore in said bracket base, wherein rotating said bolt causes a change in the position of said mounting plate relative to said bracket base, the resulting movement of said single marking or pointer relative to individual markings of said set of markings providing a visual indication to an operator of the distance of travel of said mounting plate relative to said bracket base upon rotation of said bolt.
